(19) United States
(12) Patent Application Publication
(10) Pub. No.: US 2025/0309580 A1
(43) Pub. Date: Oct. 2, 2025

(54) CONNECTOR AND SENSOR

(71) Applicant: NGK INSULATORS, LTD., Nagoya-shi (JP)

(72) Inventors: Shunsuke TABATA, Nagoya-shi (JP); Miyoshi MAKINO, Obu-shi (JP); Akihiko YAMAGUCHI, Nagoya-shi (JP)

(21) Appl. No.: 19/237,134

(22) Filed: Jun. 13, 2025

Related U.S. Application Data
(63) Continuation of application No. PCT/JP2023/042485, filed on Nov. 28, 2023.

(30) Foreign Application Priority Data
Dec. 16, 2022 (JP) 2022-200767

(51) Int. Cl. H01R 13/44; G01N 27/416; H01R 13/502; H01R 13/66

(52) U.S. Cl. CPC H01R 13/44; G01N 27/4162; H01R 13/502; H01R 13/6683

(57) ABSTRACT

A connector, which includes a plurality of contacts and is configured to bring the plurality of contacts into contact with a plurality of electrode portions provided on a surface of a sensor element having a flat plate shape, includes a pair of housings extending in an extending direction of the plurality of contacts and configured to sandwich the sensor element. At least one housing of the pair of housings includes a plurality of protruding portions extending from one end to another end of the one housing and protruding toward the sensor element, the protruding portions being formed at predetermined intervals along a direction orthogonal to the extending direction, and the contacts are respectively provided in a plurality of grooves formed by the plurality of protruding portions.

### CROSS-REFERENCE TO RELATED APPLICATIONS

This application is a Continuation of International Application No. PCT/JP2023/042485 filed on Nov. 28, 2023, which claims the benefit of priority from Japanese Patent Application No. 2022-200767 filed on Dec. 16, 2022, the contents all of which are incorporated herein by reference.

### TECHNICAL FIELD

The present invention relates to a connector and a sensor.

### BACKGROUND ART

JP 2014-209104 A discloses a sensor including a sensor element and a connector. The sensor element has a flat plate shape. A plurality of electrode portions are provided on the surface of the sensor element. The connector includes a pair of housings and a plurality of contacts. The pair of housings extend in the extending direction of the plurality of contacts. The sensor element presses the plurality of contacts against the housing, so that the plurality of contacts and the plurality of electrode portions come into contact with each other.

### SUMMARY OF THE INVENTION

However, when foreign matter such as a metal piece is mixed into the connector, the plurality of contacts may be short-circuited, and the characteristics of the sensor may be affected.

The present invention has the object of solving the aforementioned problem.

The aspects of the present invention are illustrated below.

### Item 1

A connector including a plurality of contacts and configured to bring the plurality of contacts into contact with a plurality of electrode portions provided on a surface of a sensor element having a flat plate shape, the connector comprising: a pair of housings extending in an extending direction of the plurality of contacts and configured to sandwich the sensor element, wherein at least one housing of the pair of housings includes a plurality of protruding portions extending from one end to another end of the one housing and protruding toward the sensor element, the protruding portions being formed at predetermined intervals along a direction orthogonal to the extending direction, and the contacts are respectively provided in a plurality of grooves formed by the plurality of protruding portions.

### Item 2

The connector according to Item 1, wherein the plurality of protruding portions protrude by a dimension equal to or less than a thickness of the contacts.

### Item 3

The connector according to Item 2, wherein a ratio of a protrusion length of the protruding portions to the thickness of the contacts is 0.75 to 1.00.

### Item 4

A sensor comprising: the connector according to any one of Items 1 to 3; and the sensor element.

According to the present invention, even if foreign matter such as a metal piece is mixed into the connector, it is possible to prevent the plurality of contacts from being short-circuited. Consequently, it is possible to avoid a situation in which the characteristics of a product such as a sensor are affected by a short circuit of the plurality of contacts.

### BRIEF DESCRIPTION OF DRAWINGS

FIG. 1 is a cross-sectional view of a sensor;

FIG. 2 is a cross-sectional view of a connector;

FIG. 3 is a cross-sectional view taken along line III-III of FIG. 2;

FIG. 4 is a perspective view of a contact;

FIG. 5 is a perspective view of a housing;

FIG. 6 is a plan view of the housing;

FIG. 7 is a plan view of the housing and a plurality of the contacts;

FIG. 8A is a diagram showing a first working example, and FIG. 8B is a diagram showing a second working example; and

FIG. 9A is a diagram showing a first comparative example, and

FIG. 9B is a diagram showing a second comparative example.

### DETAILED DESCRIPTION OF THE INVENTION

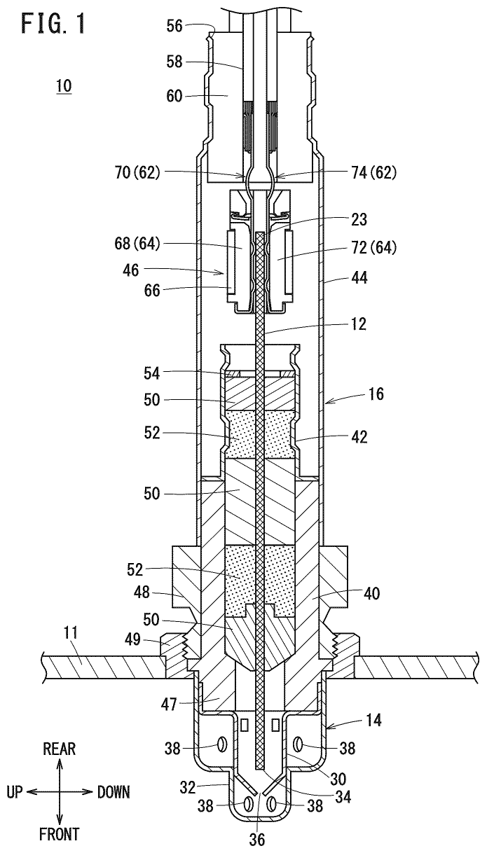

FIG. 1 is a cross-sectional view of a sensor 10 according to the present embodiment. The sensor 10 is a gas sensor for measuring a predetermined gas component in a gas to be measured. The sensor 10 is attached to a pipe such as an exhaust pipe 11 of a vehicle, for example. During operation of the vehicle, exhaust gas flows through the exhaust pipe 11. The sensor 10 measures gas components such as NOx and 02 contained in the exhaust gas, which is the gas to be measured. The sensor 10 includes a sensor element 12, a protective cover 14, and a sensor assembly 16.

As shown in FIGS. 1 to 3, the sensor element 12 has an elongated flat plate shape. In the following description, the longitudinal direction of the sensor element 12 (the up-down direction in FIG. 1) is defined as a front-rear direction. Further, the thickness direction of the sensor element 12 (the left-right direction in FIG. 1) is defined as an up-down direction. Furthermore, the width direction of the sensor element 12 (a direction perpendicular to the up-down direction and the front-rear direction) is defined as a left-right direction. In addition, in the following description, a front end portion of the sensor element 12 or the like is referred to as a distal end portion. Further, a rear end portion of the sensor element 12 or the like is referred to as a base end portion.

The sensor element 12 is formed by stacking a plurality of ceramic substrates (not shown). The ceramic substrates are each formed of an oxygen ion conductive solid electrolyte layer such as zirconia (ZrO₂).

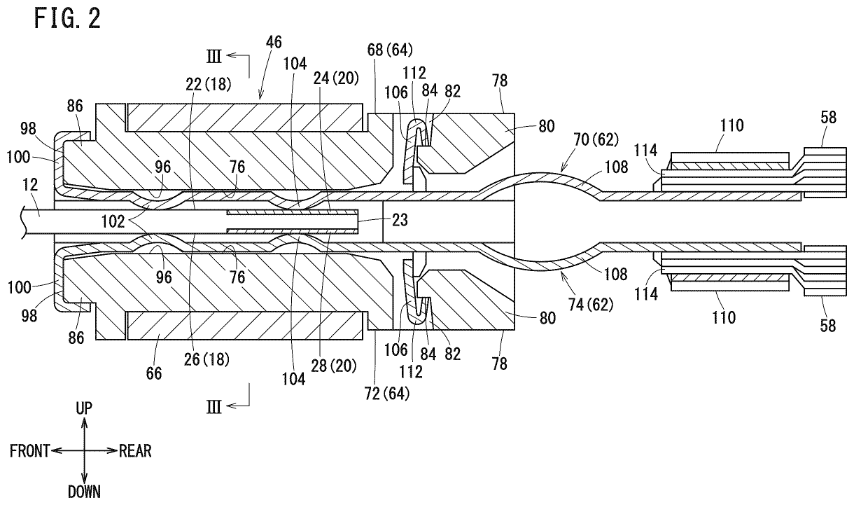

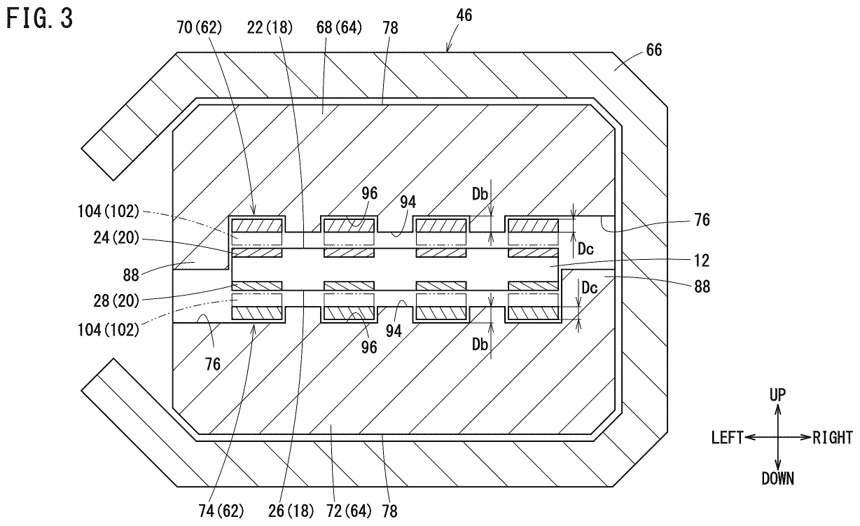

As shown in FIGS. 2 and 3, a plurality of electrode portions 20 are provided on surfaces 18 of the flat plate-shaped sensor element 12.

Specifically, a plurality of first electrode portions 24, which are the plurality of electrode portions 20, are formed at a location of a base end portion 23 of the sensor element 12 on a first surface 22, which is an upper surface among the surfaces 18 of the sensor element 12. The first electrode portions 24 extend forward from the base end portion 23 of the sensor element 12 on the first surface 22. The plurality of first electrode portions 24 are formed on the first surface 22 at predetermined intervals.

A plurality of second electrode portions 28, which are the plurality of electrode portions 20, are formed at a location of the base end portion 23 of the sensor element 12 on a second surface 26, which is a bottom surface among the surfaces 18 of the sensor element 12. The second electrode portions 28 extend forward from the base end portion 23 of the sensor element 12 on the second surface 26. The plurality of second electrode portions 28 are formed on the second surface 26 at predetermined intervals.

The plurality of first electrode portions 24 and the plurality of second electrode portions 28 face each other in the up-down direction with the sensor element 12 interposed therebetween.

As shown in FIG. 1, the protective cover 14 includes a first protective cover 30 and a second protective cover 32. The first protective cover 30 and the second protective cover 32 are made of metal. The material of the first protective cover 30 and the second protective cover 32 is, for example, stainless steel.

The first protective cover 30 is a tubular member. The first protective cover 30 covers a distal end portion 34 of the sensor element 12. The second protective cover 32 is a member having a bottomed tubular shape. The second protective cover 32 covers the first protective cover 30 and the distal end portion 34 of the sensor element 12 outside the first protective cover 30. In other words, the first protective cover 30 is an inner protective cover for the distal end portion 34 of the sensor element 12. The second protective cover 32 is an outer protective cover for the distal end portion 34 of the sensor element 12.

A first protective cover hole 36 is formed at the distal end of the first protective cover 30. A plurality of second protective cover holes 38 are formed in the side wall of the second protective cover 32. The gas to be measured flows into an internal space in which the distal end portion 34 of the sensor element 12 is accommodated, through the second protective cover holes 38 and the first protective cover hole 36. The sensor element 12 measures a predetermined gas component contained in the gas to be measured flowing into the internal space.

The sensor assembly 16 includes a main fitting 40, an inner tube 42, an outer tube 44, and a connector 46.

The main fitting 40 is a tubular member made of metal. The sensor element 12 is inserted through the main fitting 40. The distal end portion 34 of the sensor element 12 projects forward from a distal end portion 47 of the main fitting 40. The first protective cover 30 is fixed to the outside of the distal end portion 47 of the main fitting 40 by press-fitting or the like. The second protective cover 32 is fixed to the outside of the distal end portion 47 of the main fitting 40 by welding so as to cover the first protective cover 30.

A screw nut 48 is provided on the outer circumferential surface of the main fitting 40. A male threaded portion is formed on the outer circumferential surface of the screw nut 48. A fixing member 49 having a tubular shape is attached to a hole formed in the exhaust pipe 11. A female threaded portion is formed on the inner side of the fixing member 49. The sensor 10 can be attached to the exhaust pipe 11 by screwing the male threaded portion of the screw nut 48 and the female threaded portion of the fixing member 49.

The inner tube 42 is a tubular member made of metal. The inner tube 42 is fixed to the base end portion of the main fitting 40 by press-fitting or the like. The main fitting 40 and the inner tube 42 are coaxially connected to each other. Three ceramic supporters 50 are disposed at intervals in the front-rear direction on the inner side of the main fitting 40 and the inner tube 42. The sensor element 12 is inserted through the main fitting 40 while penetrating the three ceramic supporters 50 and the inner tube 42. The base end portion 23 of the sensor element 12 is located rearward of the inner tube 42.

A ceramic powder 52 such as talc is filled between the ceramic supporters 50. A metal link 54 is disposed on the inner side of the base end portion of the inner tube 42 so as to be adjacent to the ceramic supporters 50. The ceramic powder 52 is sealed by the metal link 54, the inner wall of the main fitting 40, the inner wall of the inner tube 42, and the three ceramic supporters 50.

The outer tube 44 is a tubular member made of metal. The outer tube 44 is fixed to the base end portion of the main fitting 40 by welding. An open end 56 is formed at the base end portion of the outer tube 44. The outer tube 44 covers the base end portion of the main fitting 40, the inner tube 42, the sensor element 12, and the connector 46. The outer tube 44 is disposed coaxially with the main fitting 40 and the inner tube 42.

The connector 46 is electrically connected to the plurality of first electrode portions 24 and the plurality of second electrode portions 28 (see FIG. 2). A plurality of lead wires 58 are connected to the connector 46. The plurality of lead wires 58 are electrically connected via the connector 46 to the plurality of first electrode portions 24 and the plurality of second electrode portions 28. As a result, a voltage can be applied to the sensor element 12 from the outside via the lead wires 58 and the connector 46. Further, when the sensor element 12 generates electromotive force or current corresponding to the concentration of the gas component, the electromotive force or electric power can be output to the outside via the connector 46 and the lead wires 58.

The plurality of lead wires 58 are drawn out to the outside from the open end 56 of the outer tube 44. A gap between the outer tube 44 and the plurality of lead wires 58 is sealed by a rubber plug 60.

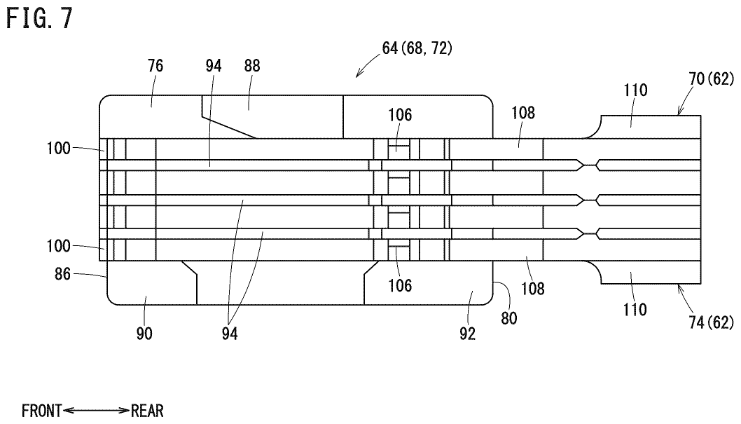

Next, the configuration of the connector 46 will be described with reference to FIGS. 2 to 8B.

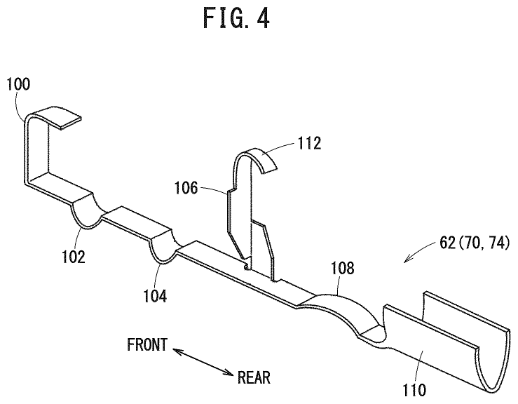

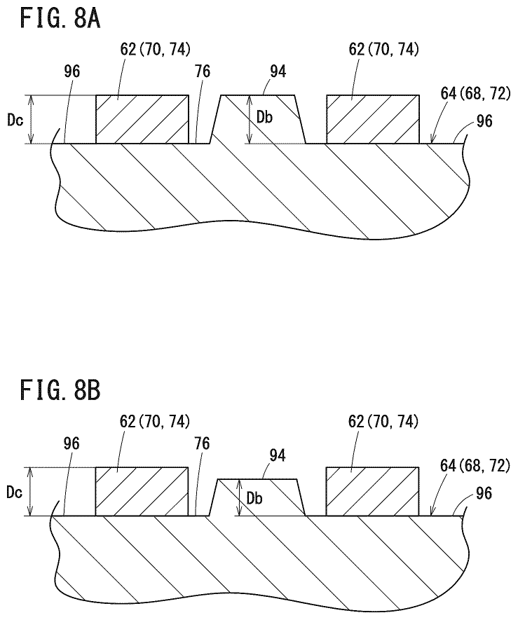

As shown in FIGS. 2 and 3, the connector 46 includes a plurality of contacts 62, a pair of housings 64, and a clamp 66. As shown in FIGS. 2 and 4, the plurality of contacts 62 are metal members extending in the front-rear direction. The plurality of contacts 62 have a same thickness Dc in the up-down direction (see FIGS. 3, 8A, and 8B). The plurality of contacts 62 contact the plurality of electrode portions 20. As shown in FIG. 2, each of the pair of housings 64 is a flat plate-shaped member extending in the front-rear direction, which is the extending direction of the plurality of contacts 62. The pair of housings 64 sandwich the sensor element 12. The housings 64 are made of ceramic such as an alumina sintered body. As shown in FIG. 3, the clamp 66 is a metal member that clamps the pair of housings 64.

Specifically, as shown in FIG. 2, one housing 64 of the pair of housings 64 is a first housing 68 disposed above the sensor element 12. A plurality of first contacts 70, which are the plurality of contacts 62, are disposed in the first housing 68. The other housing 64 is a second housing 72 disposed below the sensor element 12. A plurality of second contacts 74, which are the plurality of contacts 62, are disposed in the second housing 72. FIG. 3 illustrates a case where four first contacts 70 are disposed in the first housing 68, and four second contacts 74 are disposed in the second housing 72. The first housing 68 and the second housing 72 have the same shape. The plurality of first contacts 70 and the plurality of second contacts 74 have the same shape.

In the following description, when a configuration common to the first housing 68 and the second housing 72 is described, the first housing 68 and the second housing 72 are referred to as the housing 64. Further, when a configuration common to the first contact 70 and the second contact 74 is described, the first contact 70 and the second contact 74 are referred to as the contact 62.

As shown in FIG. 2, the housings 64 each include an inner surface 76 facing the surface 18 (the first surface 22 or the second surface 26) of the sensor element 12, and an outer surface 78 on the opposite side to the inner surface 76 and away from the sensor element 12. Therefore, as shown in FIGS. 2 and 3, the inner surface 76 of the first housing 68 and the inner surface 76 of the second housing 72 face each other with the sensor element 12 interposed therebetween.

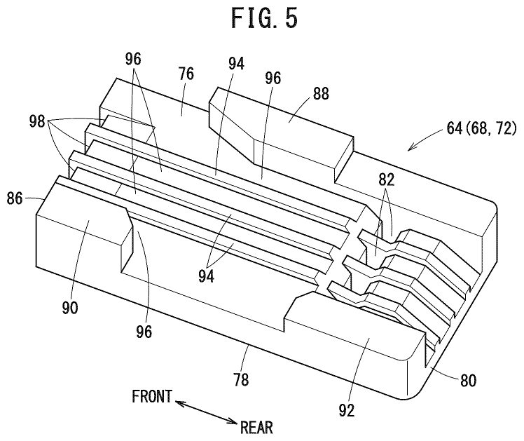

As shown in FIGS. 2 and 5, a portion of the inner surface 76 at a base end portion 80 (one end) of the housing 64 is an inclined surface that is inclined toward the rear. In addition, a plurality of insertion holes 82 are formed in the housing 64 at positions slightly forward of the inclined surface. The plurality of insertion holes 82 are provided at regular intervals in the left-right direction. The insertion holes 82 penetrate the housing 64 in the up-down direction. Locking portions 84 are respectively formed on the inner circumferential surfaces of the insertion holes 82 (see FIG. 2). Further, a portion of the inner surface 76 at a distal end portion 86 (another end) of the housing 64 is slightly inclined toward the front.

As shown in FIGS. 3 and 5, a projecting portion 88 protruding toward the surface 18 of the sensor element 12 is formed on the inner surface 76 of the housing 64 in a central portion of one of the left and right sides. Further, a first restricting portion 90 protruding toward the surface 18 of the sensor element 12 is formed on the inner surface 76 of the housing 64 at the front part of the other of the left and right sides. Furthermore, a second restricting portion 92 protruding toward the surface 18 of the sensor element 12 is formed on the inner surface 76 of the housing 64 at the rear part of the other of the left and right sides.

The protrusion amount of the projecting portion 88, the protrusion amount of the first restricting portion 90, and the protrusion amount of the second restricting portion 92 are the same. Further, the length of the projecting portion 88 in the front-rear direction is slightly shorter than the distance between the first restricting portion 90 and the second restricting portion 92 in the front-rear direction. Therefore, in the case where the base end portion 23 of the sensor element 12 is sandwiched between the first housing 68 and the second housing 72, the projecting portion 88 of the first housing 68 is disposed between the first restricting portion 90 and the second restricting portion 92 of the second housing 72, and the projecting portion 88 of the second housing 72 is disposed between the first restricting portion 90 and the second restricting portion 92 of the first housing 68.

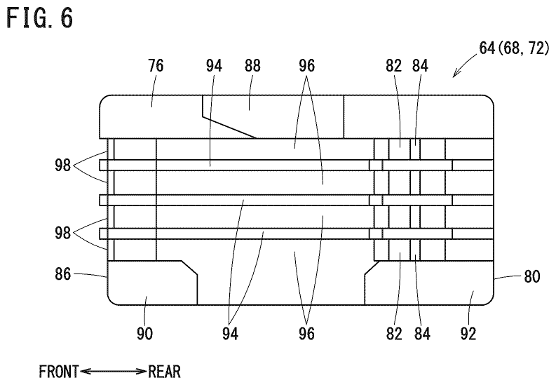

As shown in FIGS. 5 and 6, a plurality of protruding portions 94 are formed on the inner surface 76 of the housing 64. The plurality of protruding portions 94 are formed on the inner surface 76 of the housing 64 between the projecting portion 88, and the first restricting portion 90 and the second restricting portion 92. The plurality of protruding portions 94 extend from the base end portion 80 to the distal end portion 86 of the housing 64. That is, the plurality of protruding portions 94 extend in the front-rear direction on the inner surface 76 of the housing 64. As shown in FIG. 3, the plurality of protruding portions 94 protrude toward the sensor element 12. As shown in FIGS. 3, 5, and 6, the plurality of protruding portions 94 are formed at predetermined intervals in the left-right direction. The plurality of protruding portions 94 have the same width in the left-right direction. Protrusion lengths Db of the plurality of protruding portions 94 protruding toward the surface 18 (the first surface 22 or the second surface 26) of the sensor element 12 are the same. FIGS. 3, 5, and 6 illustrate a case where three protruding portions 94 are formed.

By forming the plurality of protruding portions 94, a plurality of grooves 96 are formed in the inner surface 76 of the housing 64. That is, the plurality of grooves 96 are formed to extend in the front-rear direction. The plurality of grooves 96 have the same width in the left-right direction. It should be noted that, since the projecting portion 88, the first restricting portion 90, and the second restricting portion 92 are formed on the inner surface 76 of the housing 64, FIGS. 5 and 6 illustrate a case where four grooves 96 are formed. As shown in FIG. 3, any of the contacts 62 is disposed in each of the plurality of grooves 96.

As shown in FIGS. 5 and 6, the plurality of protruding portions 94 extend around the distal end portion 86 of the housing 64 to the outer surface 78 of the housing 64. Therefore, a plurality of locking grooves 98 that are continuous with the plurality of grooves 96 are formed in the distal end portion 86 of the housing 64.

As shown in FIG. 4, the contacts 62 each include a distal end portion 100, a support portion 102, a conductive portion 104, a rising portion 106, a curved portion 108, and a holding portion 110. The distal end portion 100 is curved along the locking groove 98 (see FIG. 2) and is thereby locked in the locking groove 98. The support portion 102 is curved and protrudes toward the sensor element 12. The support portion 102 contacts the surface 18 (the first surface 22 or the second surface 26) of the sensor element 12. The conductive portion 104 is curved and protrudes toward the sensor element 12. The conductive portion 104 contacts the electrode portion 20. The rising portion 106 is inserted into the insertion hole 82. The rising portion 106 includes a hook portion 112. The hook portion 112 is locked to the locking portion 84. The curved portion 108 is curved and protrudes away from the sensor element 12. The holding portion 110 crimps and holds a plurality of core wires 114 constituting the lead wire 58 rearwardly of the housing 64.

As shown in FIG. 2, the support portion 102 and the conductive portion 104 of the contact 62 are in contact with the surface 18 of the sensor element 12. Consequently, the contact 62 receives a pressing force from the sensor element 12 via the support portion 102 and the conductive portion 104. In addition, the conductive portion 104 is electrically connected to the electrode portion 20 by the conductive portion 104 coming into contact with the electrode portion 20. Further, as shown in FIGS. 2 to 4, a portion of the contact 62 between the distal end portion 86 and the support portion 102, a portion of the contact 62 between the support portion 102 and the conductive portion 104, and a portion of the contact 62 between the conductive portion 104 and the rising portion 106 are in surface contact with the groove 96. Consequently, the contact 62 is pressed against the bottom surface of the groove 96 (the inner surface 76 of the housing 64) by the pressing force from the sensor 10. As a result, the plurality of contacts 62 and the plurality of electrode portions 20 can be appropriately brought into contact with each other.

The plurality of protruding portions 94 protrude toward the surface 18 (the first surface 22 or the second surface 26) of the sensor element 12 by a dimension equal to or less than the thickness Dc of the plurality of contacts 62. Specifically, it is desirable that a ratio Db/Dc of the protrusion length Db of the protruding portions 94 to the thickness Dc of the contacts 62 satisfies Db/Dc=0.75 to 1.00.

FIGS. 8A and 8B are diagrams showing the relationship between the contacts 62 and the protruding portions 94 in the present embodiment (a first working example, a second working example).

In the first working example shown in FIG. 8A, Dc=0.2 mm and Db=0.2 mm. Therefore, Db/Dc=1.00. In the first working example, the contacts 62 and the electrode portions 20 (see FIGS. 2 and 3) can be brought into good contact with each other. Further, in the first working example, the protrusion length Db of the protruding portion 94 located between the two contacts 62 is equal to the thickness Dc of the two contacts 62, and therefore, the two contacts 62 can be prevented from being short-circuited.

In the second working example shown in FIG. 8B, Dc=0.2 mm and Db=0.15 mm. Therefore, Db/Dc=0.75. In the second working example as well, the contacts 62 and the electrode portions 20 (see FIGS. 2 and 3) can be brought into good contact with each other. Further, in the second working example, even if the protrusion length Db of the protruding portion 94 located between the two contacts 62 is slightly smaller than the thickness Dc of the two contacts 62, the two contacts 62 can be prevented from being short-circuited.

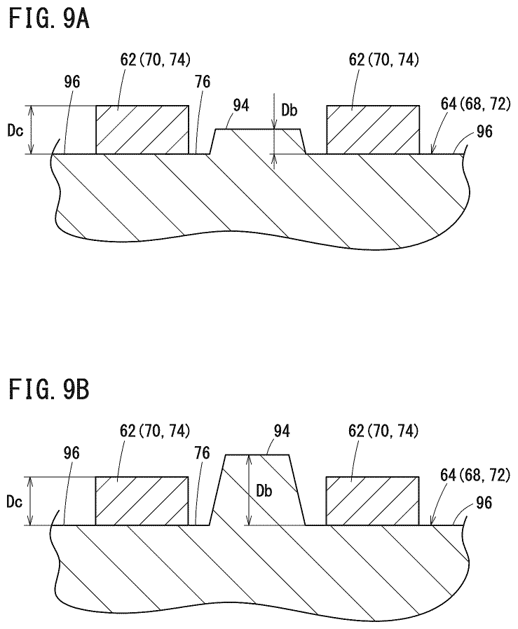

FIGS. 9A and 9B are diagrams showing the relationship between the contacts 62 and the protruding portions 94 in comparative examples (a first comparative example, a second comparative example). Incidentally, the same reference numerals are used to designate the same components as those in the first working example shown in FIG. 8A and the second working example shown in FIG. 8B.

In the first comparative example shown in FIG. 9A, Dc=0.2 mm and Db=0.1 mm. Therefore, Db/Dc=0.50. In the first comparative example, the contacts 62 and the electrode portions 20 (see FIGS. 2 and 3) can be brought into good contact with each other. However, in the first comparative example, the protrusion length Db of the protruding portion 94 located between the two contacts 62 is too small compared to the thickness Dc of the two contacts 62, and therefore, there is a possibility that the two contacts 62 are short-circuited.

In the second comparative example shown in FIG. 9B, DC=0.2 mm and Db=0.30 mm. Therefore, Db/Dc=1.50. In the second comparative example, the protrusion length Db of the protruding portion 94 located between the two contacts 62 is larger than the thickness Dc of the two contacts 62, and it is therefore possible to avoid a short circuit between the two contacts 62. However, in the second comparative example, the protruding portions 94 protrude too much toward the surface 18 of the sensor element 12 (see FIGS. 2 and 3), and it is therefore difficult to bring the contacts 62 and the electrode portions 20 into contact with each other.

It should be noted that the sensor 10 (see FIG. 1) according to the present embodiment is manufactured as follows.

First, the contact 62 is manufactured by die-cutting and then bending a metal plate.

Next, the protective cover 14 and the sensor element 12 of the sensor 10, and the main fitting 40, the inner tube 42, and the outer tube 44 of the sensor assembly 16 are assembled together. The assembling method and the assembling procedure are substantially the same as the assembling method and the assembling procedure of the sensor disclosed in JP 2014-209104 A, and therefore, the detailed description thereof is omitted.

Next, the plurality of lead wires 58 are passed through the through-holes of the rubber plug 60. Then, the plurality of core wires 114 of the lead wire 58 are crimped to the holding portion 110 of the contact 62, thereby electrically connecting the contact 62 and the lead wire 58.

Next, the contacts 62 are disposed in the plurality of grooves 96 of the housing 64. In this case, the distal end portions 100 (see FIGS. 2 and 4) of the contacts 62 are locked in the locking groove 98. Further, the rising portions 106 of the contacts 62 are inserted into the insertion holes 82, and the hook portions 112 are locked to the locking portions 84. As a result, the plurality of contacts 62 are disposed in the plurality of grooves 96 (see FIGS. 2 and 3) of the housing 64.

Next, the base end portion 23 of the sensor element 12 is sandwiched between the two housings 64 in a state where the inner surfaces 76 of the two housings 64 face each other. As a result, the plurality of contacts 62 come into contact with the plurality of electrode portions 20.

Next, the two housings 64 are clamped by the clamp 66. Accordingly, the sensor element 12 presses the plurality of contacts 62, and the plurality of contacts 62 are therefore pressed against the bottom surfaces of the plurality of grooves 96. As a result, the plurality of electrode portions 20 of the sensor element 12 are electrically connected to the lead wires 58 via the plurality of contacts 62.

Next, the rubber plug 60 is inserted into the outer tube 44 from the open end 56, and the outer tube 44 and the rubber plug 60 are reduced in diameter by swaging processing, thereby fixing the rubber plug 60 to the outer tube 44.

The sensor 10 is manufactured by the above processes.

It should be noted that, in the above description, the case where the plurality of protruding portions 94 are formed on each of the two housings 64 has been described. In the present embodiment, the plurality of protruding portions 94 may be formed on at least one housing 64 of the pair of housings 64.

The invention that can be grasped from the above embodiment will be described below.

A first aspect of the present invention is the connector (46) including the plurality of contacts (62) and configured to bring the plurality of contacts into contact with the plurality of electrode portions (20) provided on the surface (18) of the sensor element (12) having a flat plate shape, the connector including the pair of housings (64) extending in the extending direction of the plurality of contacts and configured to sandwich the sensor element, wherein at least one housing of the pair of housings includes the plurality of protruding portions (94) extending from one end (80) to the other end (86) of the one housing and protruding toward the sensor element, the protruding portions being formed at predetermined intervals along the direction orthogonal to the extending direction, and the contacts are respectively provided in the plurality of grooves (96) formed by the plurality of protruding portions.

According to the present invention, even if foreign matter such as a metal piece is mixed into the connector, it is possible to prevent the plurality of contacts from being short-circuited. Consequently, it is possible to avoid a situation in which the characteristics of a product such as a sensor are affected by a short circuit of the plurality of contacts. Therefore, according to the present invention, the fraction defective due to a short circuit can be reduced in a product using the connector. As a result, the yield of the product is improved, and the cost of the product can be reduced.

In the first aspect of the present invention, the plurality of protruding portions may protrude by a dimension equal to or less than the thickness (Dc) of the contacts.

According to this feature, it is possible to prevent the plurality of contacts from being short-circuited while bringing the plurality of contacts and the plurality of electrode portions into contact with each other.

In the first aspect of the present invention, the ratio (Db/Dc) of the protrusion length (Db) of the protruding portions to the thickness of the contacts may be 0.75 to 1.00.

According to this feature, it is possible to effectively prevent the plurality of contacts from being short-circuited.

A second aspect of the present invention is the sensor (10) including the above-described connector and the above-described sensor element.

This invention also provides the same effects as those of the first aspect.

The present invention is not limited to the above disclosure, and various modifications are possible without departing from the essence and gist of the present invention.

1. A connector including a plurality of contacts and configured to bring the plurality of contacts into contact with a plurality of electrode portions provided on a surface of a sensor element having a flat plate shape, the connector comprising:
a pair of housings extending in an extending direction of the plurality of contacts and configured to sandwich the sensor element,
wherein at least one housing of the pair of housings includes a plurality of protruding portions extending from one end to another end of the one housing and protruding toward the sensor element, the protruding portions being formed at predetermined intervals along a direction orthogonal to the extending direction, and
the contacts are respectively provided in a plurality of grooves formed by the plurality of protruding portions.

2. The connector according to claim 1, wherein
the plurality of protruding portions protrude by a dimension equal to or less than a thickness of the contacts.

3. The connector according to claim 2, wherein
a ratio of a protrusion length of the protruding portions to the thickness of the contacts is 0.75 to 1.00.

4. A sensor comprising: the connector according to claim 1; and the sensor element.
